(19) United States
(12) Patent Application Publication
(10) Pub. No.: US 2013/0038003 A1
(43) Pub. Date: Feb. 14, 2013

(54) MIXING DRUM FOR A BLAST FURNACE

(71) Applicants: Basudha K. Roy, Kolkata (IN); Some N. Ghose, Kolkata (IN)

(72) Inventors: Basudha K. Roy, Kolkata (IN); Some N. Ghose, Kolkata (IN)

(73) Assignee: TEGA Industries Limited, Kolkata, West Bengal (IN)

(21) Appl. No.: 13/522,277

(22) PCT Filed: Sep. 13, 2010
(86) PCT No.: PCT/IN2010/000612

§ 371 Date: Oct. 25, 2012

(30) Foreign Application Priority Data
Jan. 19, 2010 (IN) 41/KOL/2010

(51) Int. Cl. F27D 13/00; B29C 70/00; B01F 9/02; F27B 1/10

(52) U.S. Cl. 266/200; 264/259; 366/220

(57) ABSTRACT

Mixing drum (3) for a blast furnace including a body and adapted to accommodate Materials (1) for mixing, said drum having suitable lining system, said lining system including liners of polyurethane with ceramic blocks impregnated.

### FIELD OF THE INVENTION

The present invention in general relates to mixing drums for a blast furnace and in particular to mixing drums for blast furnaces equipped with specially designed lining system whereby homogeneous mixture is obtained out of mixing drums with greater precision and the formation of balls in the sinter mix particles for effective sintering is generated out of the mixing drums with greater precision and efficiency.

### BACKGROUND OF THE INVENTION

There is a demand on quality sinter which is essential for manufacture of hot molten metal in Blast Furnace at a low cost. Throughout the world, continuous endeavor to produce quality sinter is being observed. Mixing drums and their lining systems contribute immensely to the preparation of quality sinter raw material mix with proper capacity.

Mixing drums along with the lining system are required to perform two basic functions, namely to prepare a homogeneous mixture of all ingredients fed into it by way of churning during drum rotation and formation of balls in the sinter mix particles for effective sintering in the sintering machine.

All the minerals have abrasion resistant properties and for that abrasion resistant liners are required to save the shell. Earlier days, people used steel rods, cut piece of wire net and rubber liners also. But due to stickyness of the sinter mix materials are deposited and form a hip of materials and thereby disallow the materials to flow. Hence, capacity of the drum dropped down a lot and the drums took more power due to the excess materials sticked with the drum.

The applicants invented Poly-rubber liner design with Polymer shell plate in the year 1996. The materials of the liners had the properties of low co-efficient of friction and the lifter was designed to take care of the balling formation. The liners were installed in Primary/Secondary mixing drum, Nodulising drum and so on and the result was fantastic. The capacity of the drums increased a lot and drawing of power also went down considerably. However, the wearing of the liners are not similar for all the part for the drum.

Over the years therefore it has been observed that the life of the liners nearer to feed are lesser than the other part. Hence, extra shut down required to replace those liners which is not desirable. Hence, this design was also not sacrosanct in all respects so far as functioning of mixing drums along with the lining system are concerned, namely preparing a homogeneous mixture of all ingredients fed into it by way of churning during drum rotation and formation of balls in the sinter mix particles for effective sintering in the sintering machine. Research is on in this field for a considerable period of time, but significant improvement is yet to be achieved.

Accordingly, there was a long felt need to develop a mixing drum for a blast furnace provided with an improved lining system whereby, homogeneous mixture is obtained out of mixing drums with greater precision and the formation of balls in the sinter mix particles for effective sintering is generated out of the mixing drums with greater precision and efficiency.

The present invention meets the aforesaid long felt need.

All through out the specification including: the claims, the words “mixing drum”, “liners”, “lifter bar”, “abrasion resistant”, “wear resistant” are to be interpreted in the broadest sense of the respective terms and includes all similar items in the field known by other terms, as may be clear to persons skilled in the art. Restriction/limitation, if any, referred to in the specification, is solely by way of example and understanding the present invention.

### OBJECTS OF THE INVENTION

It is a principal object of the present invention to provide a mixing drum for a blast furnace whereby homogeneous mixture is obtained out of mixing drum with greater precision and the formation of balls in the sinter mix particles for effective sintering is generated out of the mixing drum with greater precision and efficiency.

It is a further object of the present invention to provide a mixing drum equipped with a specially designed lining for a blast furnace whereby homogeneous mixture is obtained out of mixing drum with greater precision and the formation of balls in the sinter mix particles for effective sintering is generated out of the mixing drum with greater precision and efficiency.

It is yet another object of the present invention to provide high quality sinter raw material mix at a low cost, for a blast furnace.

It is yet another object of the present invention to provide a mixing drum equipped with a specially designed lining for a blast furnace whereby life of the liners on the most wearing zone is increased by 30-35%.

It is a further object of the present invention to provide a mixing drum equipped with a specially designed lining for a blast furnace whereby down time of the mixing drum is saved due to the same life of the entire liners.

It is a further object of the present invention to provide a mixing drum equipped with a specially designed lining for a blast furnace which is easy to install and one item can be installed separately without disturbing others i.e. replacement is independent.

It is yet another object of the present invention to provide a mixing drum equipped with a specially designed lining for a blast furnace which facilitates direct monetary benefit to the user due to more life.

It is a further object of the present invention to provide a blast furnace having a plurality of mixing drums, each mixing drum being equipped with a specially designed lining for a blast furnace whereby homogeneous mixture is obtained out of mixing drum with greater precision and the formation of balls in the sinter mix particles for effective sintering is generated out of the mixing drum with greater precision and efficiency.

It is another object of the present invention to provide a method of manufacturing a mixing drum for a blast furnace, whereby homogeneous mixture is obtained out of mixing drum with greater precision and the formation of balls in the sinter mix particles for effective sintering is generated out of the mixing drum with greater precision and efficiency.

How the foregoing objects are achieved and the other aspects of the present invention will be clear from the following description which is purely by way of understanding and not by way of any sort of limitation.

### SUMMARY OF THE INVENTION

Accordingly the present invention provides a mixing drum for a blast furnace including a body and adapted to accommodate materials for mixing , said drum having suitable lining system, said lining system including liners of polyurethane with ceramic blocks impregnated.

In accordance with preferred embodiments of the mixing drum of the present invention:
said lining system includes lifter bar, said bar being made of highly wear resistant polyurethane with ceramic blocks impregnated towards the leading edge of said lifter bars.
the size, shape and number of ceramic blocks impregnated are selected, depending upon the material wear rate.
said body is cylindrical and length of drum is longer than the diameter and placed at an inclination.
said materials include iron ore, limestone, coke and dolomite.
said drum is adapted to be rotated for churning of a mixture of iron ore, limestone, coke and dolomite.

The present invention also provides a blast furnace having a plurality of mixing drums, each said mixing drum being as described hereinbefore.

Accordingly, the present invention provides a method of manufacturing a mixing drum for a blast furnace, said method including :
molding the drum to desired shape such that it is adapted to accommodate materials for mixing,
procuring raw material for preparing the liners of the lining system of the drum, said raw material including polyurethane and ceramic blocks,
molding the liners to desired shape and design including trimming and finishing the same such the liners comprise highly wear resistant poly-urethane with ceramic blocks impregnated towards the leading edge of said liners ,
installing said liners to said mixing drum with suitable means.

In accordance with preferred embodiments of the method of the present invention:
said liners include lifter bars and the step of installing the bars to the mixing drum is carried out with stud, washer and nylock nut.
said bars are molded such that it comprises highly wear resistant poly-urethane with ceramic blocks impregnated towards the leading edge of said lifter bars, the size, shape and number of ceramic blocks impregnated being selected, depending upon the material wear rate, said method further including regular monitoring of the lifter bars to access the linear wear and to establish the life achieved.

### BRIEF DESCRIPTION OF THE ACCOMPANYING DRAWINGS

The nature and scope of the present invention will be better understood from the accompanying drawings, which are by way of illustration of some preferred embodiments and not by way of any sort of limitation. In the accompanying drawings,

FIG. 1 illustrates a schematic view of the mixing drum in accordance with a preferred embodiment of the present invention.

FIG. 2 illustrates a schematic view of the mixing drum liner arrangement according to a preferred embodiment of the present invention.

FIG. 3 illustrates a side section view of the mixing drum liner arrangement shown in FIG. 2.

FIG. 4 illustrates a front section view of the mixing drum liner arrangement shown in FIG. 2.

### DETAILED DESCRIPTION OF THE INVENTION

The following describes some preferred embodiments of the present invention, which are purely for the sake of understanding the performance of the invention, and not by way of any sort of limitation.

The present invention is aimed at providing a mixing drum for a blast furnace which is adapted to ensure that homogeneous mixture is obtained out of mixing drum with greater precision and the formation of balls in the sinter mix particles for effective sintering is generated out of the mixing drum with greater precision and efficiency.

It is traditionally known that mixing drums and their lining systems contribute immensely to the preparation of quality sinter raw material mix with proper capacity. Mixing drums along with the lining systems perform two basic functions namely:

a) Preparing a homogeneous mixture of all ingredients fed into it by way of churning during drum rotation.

b) Formation of the balls in the sinter mix particles for effective sintering in the sintering machine.

In the above context, it has been observed that in mixing drums wearing of the liners is not similar for all parts of the drum. The life of the liners nearer the feed is far less than the other part. The feed of course as is known includes mixtures of iron ore, limestone, coke, and dolomite and so on. Due to differential wearing of the liner the life of the liner and the overall drum is substantially diminished hampering the quality of sinter mix coming out of the drums. It is exactly here that the present invention hits.

The present invention provides lining system for drums of a blast furnace, including liners of polyurethane with ceramic blocks impregnated towards the leading edge of the lifter bars. Preferably, the lining system includes lifter bars to take care of the extra wear. The Materials of the lifter is highly wear resistant Poly-urethane. The wear property of the Poly Urethane is much higher than the polymer in use. Ceramics blocks are impregnated towards the leading edge of the lifters as the materials are pushed by the lifters through this edge.

The aforesaid design ensures the following advantages:

1) Life of the liners on the most wearing zone is increased by 30-35%.

2) Down time of the mixing drum is saved due to the same life of the entire liners.

3) Easy to install and one item can be installed separately without disturbing others, i.e. replacement is independent.

4) Direct monetary benefit of the user due to more life.

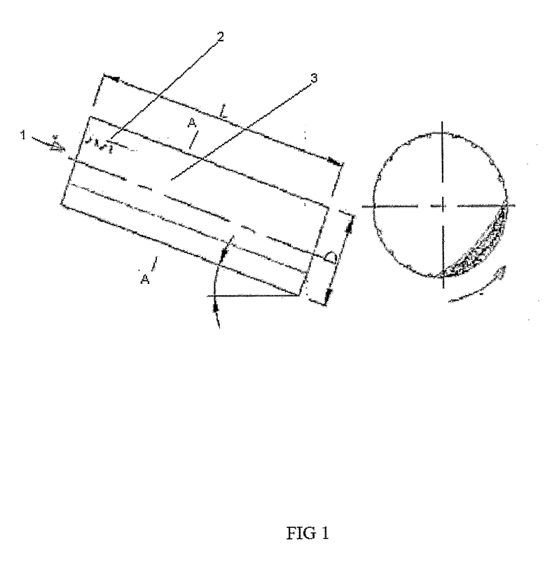

The accompanying FIG. 1 illustrates a schematic view of a preferred embodiment of the mixing drum according to the present invention. It shows the feeding. line (1), the water spray (2) and the mixing drum (3). The right hand portion of the accompanying FIG. 1 illustrates charge is lifted up and falls down like a cascade. It shows a sectional view of the left hand portion of FIG. 1 along the line A-A.

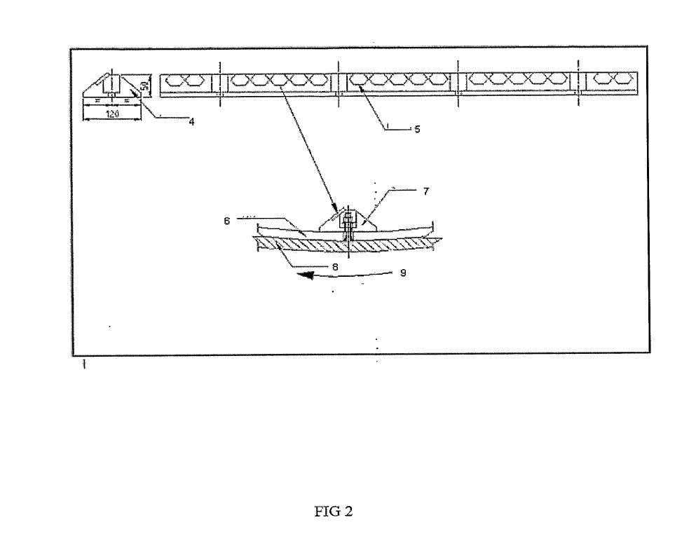

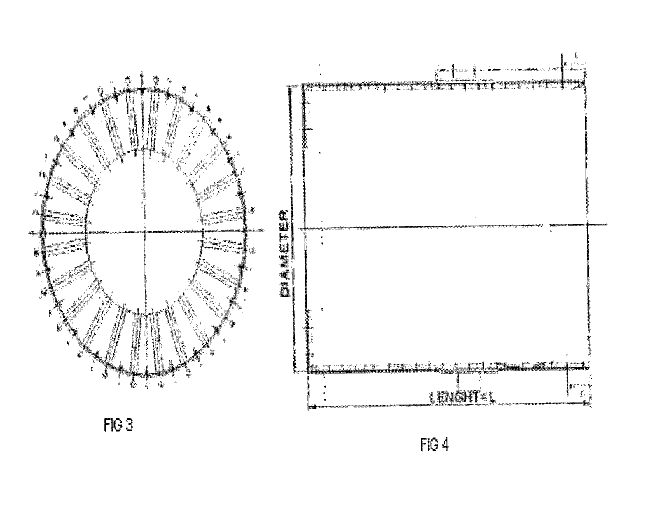

The accompanying FIG. 2 illustrates a schematic view of a preferred embodiment of the mixing drum liner arrangement, according to the present invention. It shows polyurethane material (4), ceramic hexagonal block (5), polymer shell plate (6), lifter bar (7) and mother shell plate (8). The direction of rotation of drum is also shown in the figure (9) for the sake of understanding its operation. The number, size and shape of the ceramic blocks used depend on the material wear rate. For example, the accompanying FIG. 2 illustrates ceramic blocks as hexagonal. The accompanying FIGS. 3 and 4 illustrate the side section and front section view of the mixing drum liner arrangement according to the present invention.

The lifter bar according to the present invention provides a solution for differential wear as it happens in the lining inside the mixing drum. The specialized lining system as stated before, ensures that wear rate of the lining is less. The basic shape of the product as shown in the accompanying FIGS. 1 to 4 is also proven for optimum application.

The Mixing Drums are cylindrical and the length of the drums is longer than the diameter and placed inclindly. Mixtures (Iron ore, limestone, coke, dolomite) are fed in to the drum and are rotated by means of Motor, Gear box, Pinion and Bull gear at a slow speed.

As stated before, the present invention is focused on providing a lining material for the mixing drum for protecting the steel shell from wear and tear. This is applicable at the most severe wearable zone inside the drum. Apart from the other advantages achieved by the invention as stated before, the present invention ensures that life of the liners on the most wearing zone is increased by 30-35%. This becomes possible because life of the liner inside the drum is not uniform throughout. This varies, as we go inside the drum along the length from the feeding zone. Typically, the wear rate or liner abuse is more in the zones which are close to the feeding zone or exactly the feeding zone.

The present invention also embraces a blast furnace having a plurality of mixing drums, each said mixing drum having an improved lining configuration as described hereinabove.

The method of manufacturing a mixing drum for a blast furnace according to the present invention first of all includes molding the drum to desired shape such that it is adapted to accommodate materials for mixing. Thereafter, raw materials are procured for preparing the liners of the lining system of the drum, said raw material including polyurethane and ceramic blocks. Then, the liners are molded to desired shape and design including trimming and finishing the same such that the liners comprise highly wear resistant poly-urethane with ceramic blocks impregnated towards the leading edge of said liners. Then liners are installed to said mixing drum with suitable means such as stud, washer and nylock nut. Preferably, the liners include lifter bars. Preferably the bars are molded such that it comprises highly wear resistant poly-urethane and ceramic blocks impregnated towards the leading edge of said lifter bars. The size, shape and number of ceramic blocks impregnated are selected, depending upon the material wear rate. The method also includes regular monitoring of the lifter bars to access the linear wear and to establish the life achieved.

The present invention has been described with reference to some drawings and preferred embodiments, purely for the sake of understanding and not by way of any limitation and the present invention includes all legitimate developments within the scope of what has been described hereinbefore and claimed in the appended claims.

1. Mixing drum for a blast furnace including a body and adapted to accommodate materials for mixing, said drum having suitable lining system, said lining system including liners of polyurethane with ceramic blocks impregnated.

2. The mixing drum as claimed in claim 1 wherein said lining system includes lifter bar, said bar being made of highly wear resistant poly-urethane with ceramic blocks impregnated towards the leading edge of said lifter bars.

3. The mixing drum as claimed in claim 2 wherein the size, shape and number of ceramic blocks impregnated are selected, depending upon the material wear rate.

4. The mixing drum for a blast furnace as claimed in claim 1 wherein said body is cylindrical and length of drum is longer than the diameter and placed at an inclination.

5. The mixing drum as claimed in claim 1 wherein said materials include iron ore, limestone, coke and dolomite.

6. The mixing drum as claimed in claim 5, wherein said drum is adapted to be rotated for churning of a mixture of iron ore, limestone, coke and dolomite.

7. A blast furnace having a plurality of mixing drums, each said mixing drum including a body and adapted to accommodate materials for mixing, said drum having suitable lining system, said lining system including liners of polyurethane with ceramic blocks impregnated.

8. A method of manufacturing a mixing drum for a blast furnace, said method including:
molding the drum to desired shape such that it is adapted to accommodate materials for mixing,
procuring raw material for preparing the liners of the lining system of the drum, said raw material including polyurethane and ceramic blocks,
molding the liners to desired shape and design including trimming and finishing the same such the liners comprise highly wear resistant poly-urethane with ceramic blocks impregnated towards the leading edge of said liners
installing said liners to said mixing drum with suitable means.

9. The method of manufacturing a mixing drum of a blast furnace as claimed in claim 8 wherein said liners include lifter bars and the step of installing the bars to the mixing drum is carried out with stud, washer and nylock nut.

10. The method of manufacturing a mixing drum as claimed in claim 9 wherein said bars are molded such that it comprises highly wear resistant poly-urethane with ceramic blocks impregnated towards the leading edge of said lifter bars, the size, shape and number of ceramic blocks impregnated being selected, depending upon the material wear rate, said method further including regular monitoring of the lifter bars to access the linear wear and to establish the life achieved.
